(19) United States
(12) Patent Application Publication
(10) Pub. No.: US 2018/0009715 A1
(43) Pub. Date: Jan. 11, 2018

(54) ARTIFICIAL GRAPHITE FLAKE MANUFACTURING METHOD AND PRODUCT THEREOF

(71) Applicant: Pin Yu KO, New Taipei City (TW)

(72) Inventor: Pin Yu KO, New Taipei City (TW)

(21) Appl. No.: 15/204,434

(22) Filed: Jul. 7, 2016

(51) Int. Cl. C04B 35/52; B32B 5/16; C04B 35/626; B32B 27/28; B32B 37/06

(52) U.S. Cl. CPC C04B 35/522; B32B 27/281; B32B 37/06; C04B 35/6265; B32B 5/16; B32B 2305/72; C04B 2235/425; C04B 2235/48; B32B 2307/202

(57) ABSTRACT

The present invention discloses an artificial graphite flake manufacturing method, which uses the PI (polyimide) films as the material; via a stacking step, a first heating step and a second heating step, the PI films are processed to form the artificial graphite flakes so as to increase the lubrication and the hardness, improve the heat conduction for balancing temperature increase and better the smoothness; in addition, via a perforation step, a hole structure is formed on the artificial graphite flakes so as to increase the heat diffusion area and the air permeability of the artificial graphite flakes, and then increase the defect-free rate and the smoothness thereof.

### FIELD OF THE INVENTION

The present invention generally relates to a method for manufacturing graphite flakes, in particular to a method for manufacturing artificial graphite flakes and the application thereof.

### DESCRIPTION OF THE RELATED ART

Circuit boards used in various electronic products are usually made of the material with good heat conductivity capable of properly dissipating the heat and keeping great operation performance in order to satisfy the requirements of electronic products.

However, with the advance of technology, various high-power and high-performance 3C electronic products are developed one by one; due to the performance increase of 3C electronic products, the heat dissipation requirements of various hardware accessories will become stricter. Take a high-power LED as an example, as the high-power LED operating in high watt will generate higher heat, conventional heat dissipation substrate can no longer satisfy the heat diffusion and heat conduction problems, which will not only influence the performance and the quality in use, but also limit the service life of the high-power LED; accordingly, the high-power LED cannot be normally used for a long time.

Therefore, the performance of heat dissipation substrates is always the most important issue for electronic products, and graphite flakes are the major material of heat dissipation substrates; the inventor of the invention has kept trying to improve graphite flakes, and then finally creates the invention after continuous trials and experiments.

### SUMMARY OF THE INVENTION

Therefore, it is a primary objective of the present invention to provide an artificial graphite flake manufacturing method, which alternately stacks natural graphite dust papers and polyimide (PI) films so as to increase the lubrication and the hardness, improve the heat conduction for balancing temperature increase of the PI films and then better the smoothness thereof.

To achieve the foregoing objective, the present invention provides an artificial flake manufacturing method for manufacturing artificial graphite flakes by PI (polyimide) films; the method includes a stacking step, a first heating step and a second heating step; more specifically, the stacking step is to alternately stack the PI films and natural graphite dust papers to make each PI film be sandwiched by two of the natural graphite dust papers; the first heating step is to heat up the stacked PI films to 1000˜1200° C. in stages so as to carbonize the PI films to be the half-finished products; the second heating step is to keep the carbonized half-finished products under stacking status, and heat up the carbonized half-finished products to 2500˜3000° C. in stages so as to graphitize the half-finished products to be the artificial graphite flakes.

Particularly, the thickness of the PI films adopted by the present invention is preferably between 10˜200 μm, and the thickness of the carbonized artificial graphite flakes is also preferably between 10˜200 μm.

Preferably, the method may further include a perforation step before the stacking step, and the perforation step is to form a plurality of holes with diameter of 0.1˜1 mm on each of the artificial graphite flakes.

Preferably, the method may further include a perforation step after the second heating step, and the perforation step is to form a plurality of holes with diameter of 0.1˜1 mm on each of the artificial graphite flakes.

Preferably, the holes are arranged to be an array or a plurality of sloping lines, and the interval between any two adjacent holes is between 0.1˜5 mm

Accordingly, by means of the hole structure of the holes of the PI films (10˜200 μm) or the artificial graphite flakes (10˜200 μm formed by the perforation step, the heat diffusion area and the air permeability of the artificial graphite flakes; therefore, the heat diffusion function and the heat conduction function of the artificial graphite flakes can be better than conventional graphite flakes; further, the holes can provide the space for inflation or compression, so the defect-free rate and the smoothness can be improved in either the heating process or the following process of pressing the artificial graphite flakes to form the heat dissipation substrates.

Further, the artificial graphite flakes can be properly applied to electronic products with the structure that the electrodes are separated from the heat dissipation substrate; besides, during the application process, the adhesion of the attached resin layer can be increased via the holes and the problem that the graphite flakes tend to crack due to following processing steps can be solved.

Preferably, the stacking step is further to accommodate the alternately stacked PI films and the natural graphite dust papers by a graphite box and graphite boards, and the graphite box has a predetermined space for inflation; by means of the great heat conduction characteristic of the graphite, the temperature distribution can be more uniform during the heating process and the smoothness of the finished products can be improved via the weight of the graphite board.

Preferably, the first heating step and the second heating step can adopt a resistance-type heating furnace or a sensing-type heating furnace for heating in stages.

According to the above manufacturing method, the present invention further provides an artificial graphite flake, which includes a hole structure formed by a perforation step, and the diameter of the holes is between 0.1˜1 mm; the holes are arranged to be an array or a plurality of sloping lines, and the interval between any two adjacent holes is between 0.1˜5 mm.

Furthermore, the present invention still further provides a stacking structure of a graphite substrate, and the basic structure thereof includes an artificial graphite flake, a base layer, a conduction layer and an isolating layer; more specifically, the artificial graphite flake is the finished product manufactured by the aforementioned manufacturing method; the base layer is disposed under the artificial graphite flake, and made of metal, resin or wood fiber; the conducting layer is disposed above the artificial graphite flake, and made of conducting material; the isolating layer is corresponding to the conducting layer, and is attached to the bottom of the conducting layer, where the isolating layer is made of isolating composite material.

Preferably, the structure may further include an additional isolating layer between the base layer and the artificial graphite flake.

Preferably, the conducting layer is made of conducting metal material, and the isolating layer is made of heat curing resin material or polymeric resin material.

Preferably, the thickness of the artificial graphite flake is between 10˜200 μm; the base layer may be an aluminum layer with thickness of 10˜3000 μm, a copper layer with thickness of 10˜175 μm, a resin material layer with thickness of 10˜3000 μm or a wood fiber layer with the thickness of 10˜200 μm; the conducting layer may be a copper layer with thickness of 10˜175 μm, and the isolating layer may be a PP (prepreg) material layer with thickness of 10˜130 μm.

To sum up, the graphite substrate formed by the artificial graphite flakes not only can be applied to electronic products with the structure that the electrodes are separated from the heat dissipation substrate, but also has the following features:

1. The graphite substrate is not only of high heat conduction coefficient, but also of high horizontal heat conduction coefficient and great heat equalization, which can improve the overall heat dissipation of the substrate.

2. The graphite substrate is of low heat inflation coefficient, stable in the manufacturing process and can achieve high defect-free rate.

3. The heat conduction performance of the graphite substrate is better than that of the aluminum substrate or the copper substrate, and the heat resistance of the graphite substrate is lower than that of the aluminum substrate or the copper substrate.

4. Due to the performance improvement and the size reduction, the hardware design and the assembly cost of the product can be further reduced.

5. Via high-efficiency heat conduction and heat dissipation, the service life and the usage stability of the product can be improved.

The technical content of the present invention will become apparent by the detailed description of the following embodiments and the illustration of related drawings as follows.

### BRIEF DESCRIPTION OF THE DRAWINGS

FIG. 1 is a flowchart in accordance with an embodiment of the present invention.

FIG. 2 and FIG. 3 are flowcharts in accordance with other embodiments of the present invention.

FIG. 4 is a schematic view of a stacking status in accordance with an embodiment of the present invention.

FIG. 5 is a schematic view of the appearance and partial enlargement of an artificial graphite flake in accordance with an embodiment of the present invention.

FIG. 6 is a top view of the partial structure of an artificial graphite flake in accordance with an embodiment of the present invention.

FIG. 6a and FIG. 6b are schematic views of the partial structures of artificial graphite flakes in accordance with other embodiments of the present invention.

FIG. 7-FIG 10 are schematic views of graphite substrate stacking structures in accordance with the embodiments of the present invention.

### REPRESENTATIVE FIGURE

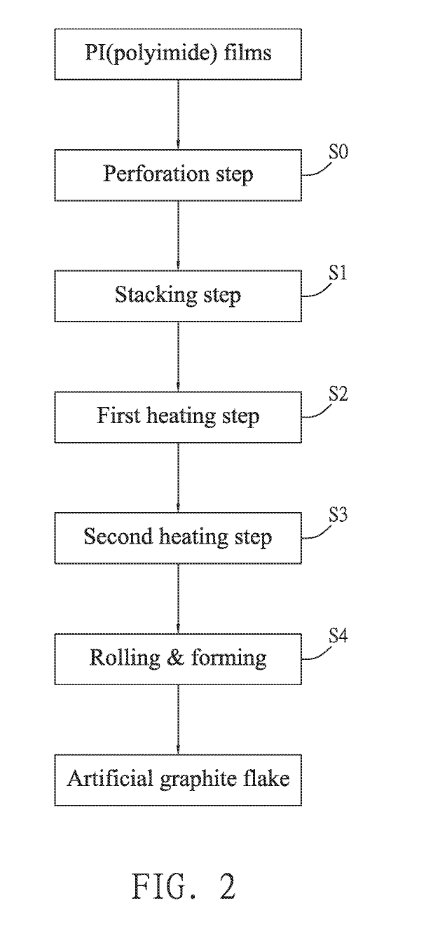

### REPRESENTATIVE IFGURE OF THE INVENTION FIG. 2

### ELEMENT DESCRIPTION OF THE PREPRESENTATIVE FIGURE

S1 Stacking step

S2 First heating step

S3 Second heating step

S4 Rolling & forming

S0 Perforation step

### DETAILED DESCRIPTION OF THE PREFERRED EMBODIMENTS

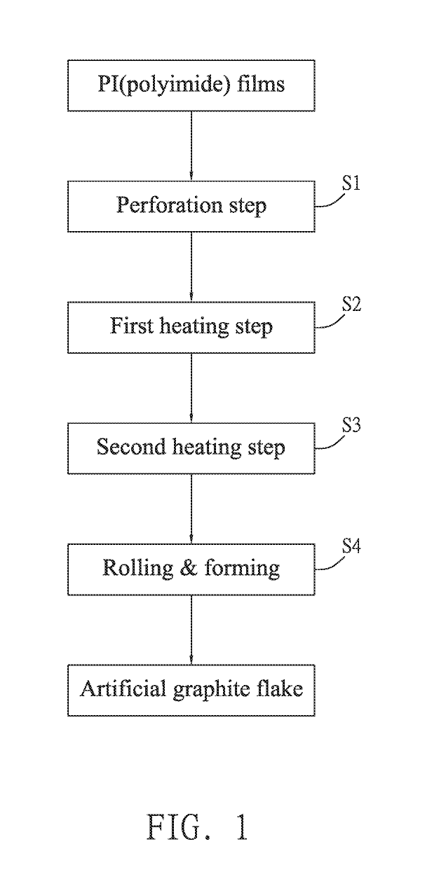

Please refer to FIG. 1; the main flow of the artificial graphite flake manufacturing method in accordance with the present invention includes a stacking step S1, a first heating step S2, a second heating step S3, rolling and forming S4, etc.; of course, before stacking, it is necessary to select a predetermined material, polyimide (PI), and then cut the material into a plurality of PI films with predetermined size; then, the process proceeds to the stacking step S1.

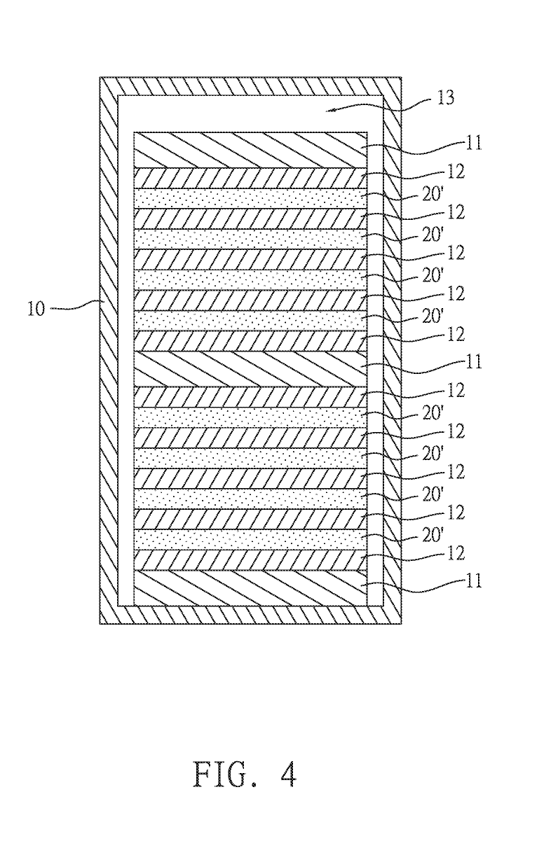

The stacking step S1 is to alternately stack the PI films and natural graphite dust papers so as to make each PI film is sandwiched by two natural graphite dust papers. Regarding the type of the stacking, as shown in FIG. 4, the PI films 20′ and the natural graphite dust papers 12 are alternately stacked to the predetermined layer number or height; then at least two graphite boards 12 are inserted into the stacked PI films 20′ and the natural graphite dust papers 12, and press the top and the bottom of the stacked PI films 20′ and the natural graphite dust papers 12; afterward, all of which are putted into and fixed in a graphite box 10, and the stacking height is slightly lower than the depth of the graphite box 10; therefore, the graphite box 10 can have a predetermined space 13 for the inflation due to the following heating processing steps.

After the stacking step S1 is finished, the first heating step S2 is performed first, which puts the graphite box 10 into the low-temperature heating furnace, and then perform the carbonization operation via 1000˜1200° C. heating in stages so as to carbonize the PI films 20′ to be the half-finished product; after the first heating step S2 is finished, the second heating step is executed, which takes out the half-finished product and then puts the half-finished product into the high-temperature heating furnace so as to graphitize the half-finished product via 2500˜3000° C. heating in stages; then, the half-finished product can be graphitized to be the artificial graphite flake 20; after the above process is finished, the stacking structure is taken out and then disassembled; afterward, the finished product of the artificial graphite flake 20 is obtained after the rolling step and the forming step.

In a preferred embodiment, the heating furnace may be a resistance-type heating furnace or a sensing-type heating furnace; the heating furnace adopted by the carbonization reaction is a low-temperature carbonization furnace, and the heating furnace of the graphitization reaction is a high-temperature heating furnace.

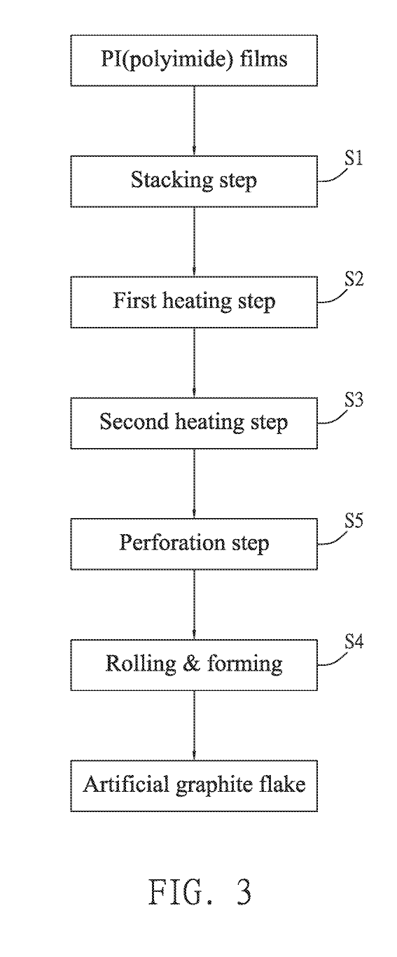

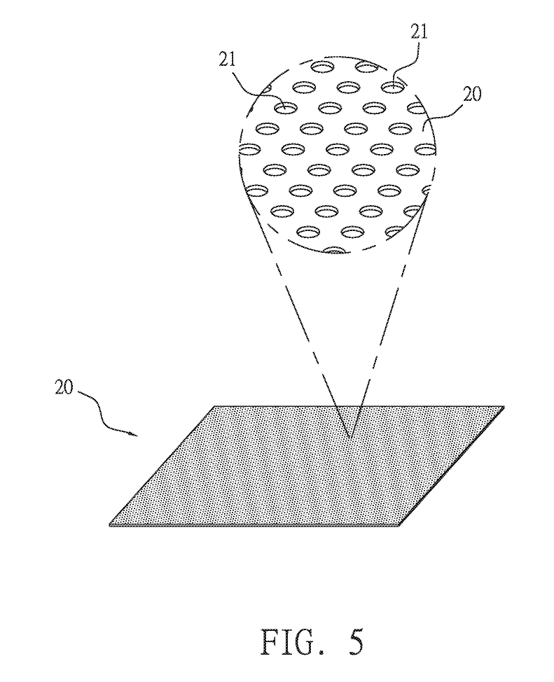

Please refer to FIG. 2, FIG. 3 and FIG. 5; a perforation step S0, S5 can be further added into the manufacturing process of the embodiment, which can form a plurality of holes 21 with diameter of 0.1˜1 mm As shown in FIG. 2, the perforation step S0 is to execute the perforation operation before the stacking step S1, and the holes formed by which can provide the space for the inflation due to heating so as to increase the defect-free rate and the smoothness of the artificial graphite flake 20 after heating reaction; thus, the diameter of the holes 21 after the heating reaction will have the contract ratio of 5˜15%; for example, if the diameter of the holes of the PI films is 1 mm, the diameter of the holes 21 of artificial graphite flake 20 will contract to be 0.85˜0.95 mm after the heating reaction; as shown in FIG. 3, the perforation operation is executed after the second heating step S2, which can accurately control the size of the holes 21 to keep stable heat diffusion and the air permeability.

Accordingly, via the hole structure formed by the holes 21 on the PI films 20′ and the artificial graphite flakes 20 during the perforation step S0, S5, the heat diffusion area and the air permeability of the artificial graphite flakes 20 can be increased; thus, the heat diffusion function and the heat conduction function of the artificial graphite flakes 20 can be much better than conventional graphite flakes; further, the holes 20 can form the space for inflation or contracting; therefore, the defect-free rate and the smoothness can be increased in either the heating process or the following process of pressing the artificial graphite flakes to form the heat dissipation substrates.

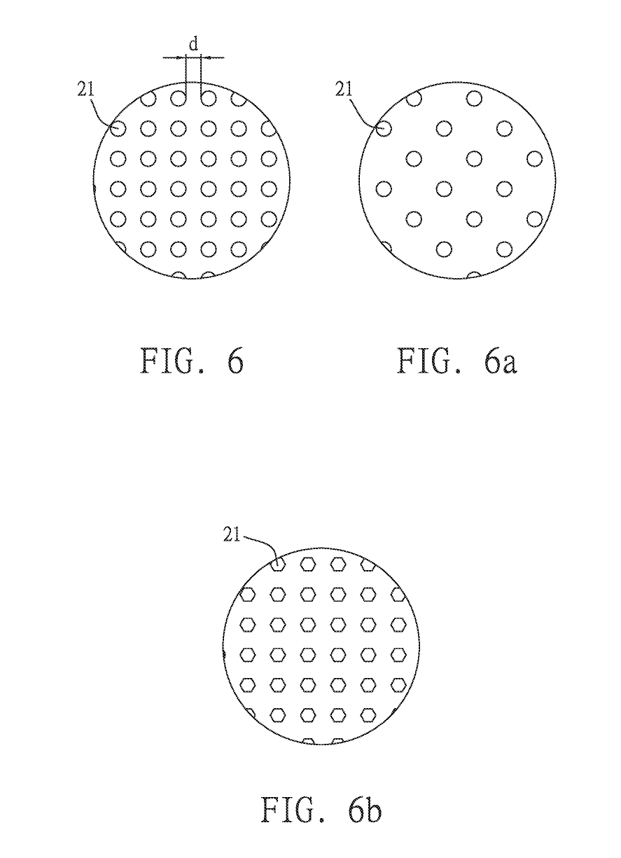

In a preferred embodiment, the holes 21 formed by the perforation step S0, S5 (or the holes 21 of the artificial graphite flakes 20) can be distributed to form an array (as shown in FIG. 6) or a plurality of sloping lines (as shown in FIG. 6a); besides, the interval d of any two adjacent holes 21 is between 0.1˜5 mm Further, the holes 21 not only can be circular, but also can be hexangular holes 21 outside the inscribed circle (or inside the circumscribed circle) with diameter of 0.1˜1 mm; as shown in FIG. 6b, the holes 21 of the artificial graphite flakes 20 are the hexangular holes 21 outside the inscribed circle.

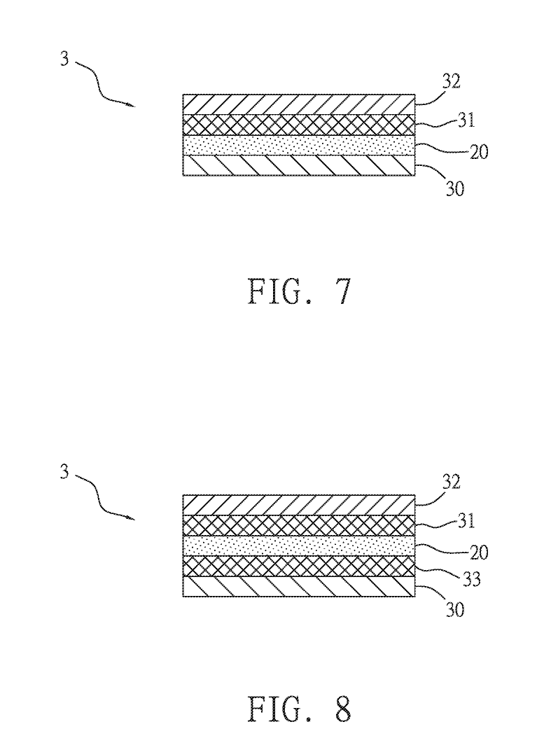

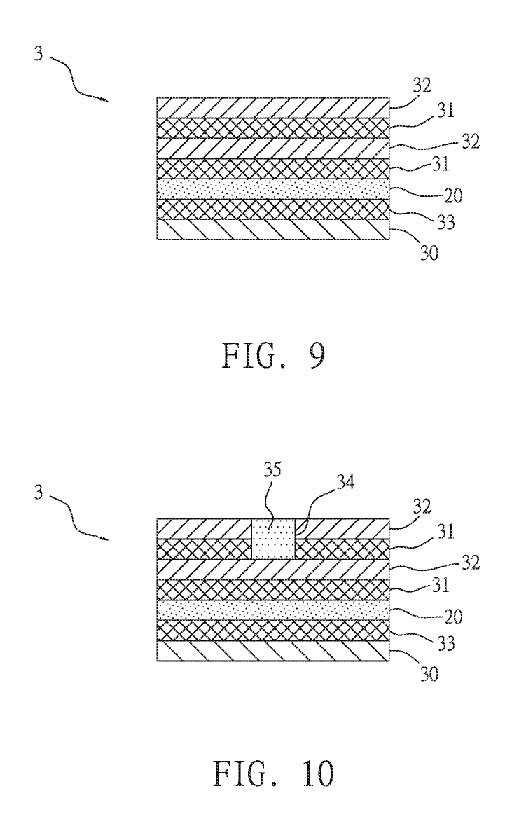

Please refer to FIG. 7, which is a schematic view of the stacking structure of the graphite substrate 3 manufactured by further processing the aforementioned artificial graphite flake 20; the structure includes an artificial graphite flake 20, a base layer 30, at least one conducting layer 31 and at least one isolating layer 32; more specifically, the base layer 30 is disposed below the artificial graphite flake 20 and made of metal, resin or wood fiber; the conducting layer 31 is disposed above the artificial graphite flake 20 and made of the conducting material; the isolating layer 31 is corresponding to the conducting layer 31 and attached to the bottom of the conducting layer 31, wherein the isolating layer 32 is made of isolating composite material.

The stacking structure of the graphite substrate 3 shown in FIG. 7 is an embodiment of a single-layer graphite substrate 3; of course, as shown in FIG. 8, an additional isolating layer 33 can be inserted between the base layer 30 and the artificial graphite flake 20 according to the requirements to form anther embodiment of the single-layer graphite substrate 3; the material of the additional isolating layer 33 is the same with the isolating layer 31 and can be made of isolating composite material.

In addition, a plurality of conducting layers 32 can be disposed above the artificial graphite flake 20 according to the requirements to form a multi-layer graphite substrate 3; as shown in FIG. 9, two conducting layers 32 are disposed above the artificial graphite flake 20, and the bottom of each of the conducting layers 32 is disposed with the corresponding isolating layer 31, whereby the stacking structure of a double-layer graphite substrate 3 is formed.

Furthermore, as shown in FIG. 10, at least perfusion hole 24 can be formed at the conducting layer 32 at the top and the corresponding isolating layer 31 of the graphite substrate 3, and the perfusion material 25 is injected into perfusion hole 24 so as to match the circuit structure of electronic equipment and enhance the heat transmission ability of the vertical direction of the graphite substrate 3; more specifically, the perfusion material 25 can be cooper paste, silver paste, resin or electroplating copper.

In all embodiments of the present invention, the material of the isolating layer 31 can be heat curing resin or polymeric resin; the material of the conducting layer 31 can be conducting metal material (such as copper foil). Besides, the material of the base layer 30, the isolating layer 31 and the conducting layer 32 can be properly selected according to the actual requirements and be of appropriate thickness; more specifically, compared the material cost and the heat conducting performance, the preferred base layer 20 can be an aluminum layer with thickness of 10˜3000 μm, a copper layer with thickness of 10˜175 μm, a resin layer with thickness of 10˜3000 μm or a wood fiber layer with thickness of 10˜200 μm; the preferred isolating layer 31 can be a PP (prepreg) layer with thickness of 10˜130 μm; the preferred conducting layer 32 can be a copper layer with thickness of 10˜175 μm.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

### DESCRIPTION OF ELELEMTNS

S1 Stacking step

S2 First heating step

S3 Second heating step

S4 Rolling & forming

S0, S5 Perforation step

P PI (Polyimide) film

10 Graphite box

11 Graphite board

12 Natural graphite dust paper

13 Predetermined space

20 Artificial graphite flake

21 Hole

d Interval

3 Graphite substrate

30 Base layer

31 Isolating layer

32 Conducting layer

33 Additional isolating layer

34 Perfusion hole

35 Perfusion material

What is claimed is:

1. An artificial graphite flake manufacturing method for manufacturing artificial graphite flakes by PI (polyimide) films, comprising:
a stacking step for alternately stacking the PI films and natural graphite dust papers to make each PI film be sandwiched by two of the natural graphite dust papers, and then accommodating the alternately stacked PI films and the natural graphite dust papers by a graphite box and graphite boards, and the graphite box having a predetermined space for inflation;
a first heating step for heating up the stacked PI films to 1000˜1200° C. in stages to carbonize the PI films to be half-finished products;
a second heating step for keeping the carbonized half-finished products under a stacking status, and heating up the carbonized half-finished products to 2500˜3000° C. in stages so as to graphitize the half-finished products to be the artificial graphite flakes.

2. The artificial graphite flake manufacturing method of claim 1, wherein before the stacking step further comprising a perforation step for forming a plurality of holes with a diameter of 0.1˜1 mm on each of the artificial graphite flakes.

3. The artificial graphite flake manufacturing method of claim 1, wherein after the second heating step further comprising a perforation step for forming a plurality of holes with a diameter of 0.1˜1 mm on each of the artificial graphite flakes.

4. The artificial graphite flake manufacturing method of claim 2, wherein the holes are arranged to be an array or a plurality of sloping lines, and an interval between any two adjacent holes is between 0.1˜5 mm.

5. The artificial graphite flake manufacturing method of claim 4, wherein the first heating step and the second heating step adopt a resistance-type heating furnace or a sensing-type heating furnace for heating.

6. The artificial graphite flake manufacturing method of claim 3, wherein the holes are arranged to be an array or a plurality of sloping lines, and an interval between any two adjacent holes is between 0.1˜5 mm.

7. The artificial graphite flake manufacturing method of claim 6, wherein the first heating step and the second heating step adopt a resistance-type heating furnace or a sensing-type heating furnace for heating.

8. A stacking structure of a graphite substrate, comprising:
an artificial graphite flake, manufactured by the manufacturing method of claim 2;
a base layer, disposed under the artificial graphite flake, and made of a metal, a resin or a wood fiber;
an additional isolating layer, disposed between the base layer and the artificial graphite flake, and made of an isolating composite material;
at least one conducting layer, disposed above the artificial graphite flake, and made of a conducting material; and
at least one isolating layer corresponding to the conducting layer, the isolating layer being attached to a bottom of the conducting layer and made of the isolating composite material.

9. The stacking structure of the graphite substrate of claim 8, wherein the conducting layer is made of a conducting metal material, and the isolating layer is made of a heat curing resin material or a polymeric resin material.

10. A stacking structure of a graphite substrate, comprising:
an artificial graphite flake, manufactured by the manufacturing method of claim 3;
a base layer, disposed under the artificial graphite flake, and made of a metal, a resin or a wood fiber;
an additional isolating layer, disposed between the base layer and the artificial graphite flake, and made of an isolating composite material;
at least one conducting layer, disposed above the artificial graphite flake, and made of a conducting material; and
at least one isolating layer corresponding to the conducting layer, the isolating layer being attached to a bottom of the conducting layer and made of the isolating composite material.

11. The stacking structure of the graphite substrate of claim 10, wherein the conducting layer is made of a conducting metal material, and the isolating layer is made of a heat curing resin material or a polymeric resin material.
